(19) United States
(12) Patent Application Publication
(10) Pub. No.: US 2026/0045482 A1
(43) Pub. Date: Feb. 12, 2026

(54) RECHARGEABLE LITHIUM BATTERY AND METHOD OF FABRICATING THE SAME

(71) Applicant: SAMSUNG SDI CO., LTD., Yongin-si (KR)

(72) Inventor: Hyunwoo KIM, Yongin-si (KR)

(73) Assignee: SAMSUNG SDI CO., LTD., Yongin-si (KR)

(21) Appl. No.: 19/281,948

(22) Filed: Jul. 28, 2025

(30) Foreign Application Priority Data
Aug. 9, 2024 (KR) 10-2024-0106570

(51) Int. Cl. H01M 4/13; H01M 4/02; H01M 4/66; H01M 10/0525; H01M 10/0585; H01M 50/54; H01M 50/636

(52) U.S. Cl. CPC H01M 4/13; H01M 4/661; H01M 4/667; H01M 10/0525; H01M 10/0585; H01M 50/54; H01M 50/636; H01M 2004/021

(57) ABSTRACT

Disclosed are rechargeable lithium batteries and fabrication methods thereof. The rechargeable lithium battery includes unit cells that are stacked, and a separator between the unit cells. At least one of the unit cells includes a composite current collector that has a top surface and a bottom surface that are opposite to each other, a first active material layer on the top surface of the composite current collector, and a second active material layer on the bottom surface of the composite current collector. The composite current collectors of neighboring unit cells are in contact with each other.

### CROSS-REFERENCE TO RELATED APPLICATION

This U.S. nonprovisional application claims priority under 35 U.S.C § 119 to Korean Patent Application No. 10-2024-0106570 filed on Aug. 9, 2024 in the Korean Intellectual Property Office, the disclosure of which being hereby incorporated by reference in its entirety.

### BACKGROUND

The present disclosure relates to a composite substrate for a rechargeable lithium battery, and a rechargeable lithium battery including the composite substrate.

With increasing presence of battery-using electronic devices, such as, e.g., mobile phones, laptop computers, electric vehicles, and the like, there is increasing demand for rechargeable batteries with high energy density and high capacity. Therefore, improving performance of rechargeable lithium batteries may be advantageous.

A rechargeable lithium battery typically includes a positive electrode, a negative electrode, and an electrolyte, the positive and negative electrodes include an active material in which intercalation and deintercalation are possible, and the rechargeable lithium battery generates electrical energy caused by oxidation and reduction reactions when lithium ions are intercalated and deintercalated.

### SUMMARY

An example embodiment of the present disclosure includes a rechargeable lithium battery using a composite current collector.

According to an example embodiment of the present disclosure, a rechargeable lithium battery may include a plurality of unit cells that are stacked, and a separator between the plurality of unit cells. Each of, or at least one of, the plurality of unit cells may include a composite current collector that has a top surface and a bottom surface that are opposite to each other, a first active material layer on the top surface of the composite current collector, and a second active material layer on the bottom surface of the composite current collector. The composite current collectors of neighboring unit cells may be in contact with each other.

According to an example embodiment of the present disclosure, a rechargeable lithium battery may include a plurality of unit cells that are stacked, a separator between the plurality of unit cells, and an electrolyte in contact with the separator. Each of, or at least one of, the plurality of unit cells may include a composite current collector, a first active material layer on a top surface of the composite current collector, and a second active material layer on a bottom surface of the composite current collector. The electrolyte may be in contact with the first active material layer, the second active material layer, and the separator. The composite current collectors of neighboring unit cells may be in contact with each other.

According to an example embodiment of the present disclosure, a method of fabricating a rechargeable lithium battery may include stacking a plurality of unit cells, wherein each of, or at least one of, the plurality of unit cells includes a composite current collector, among a first surface, a second surface, a third surface, and a fourth surface of each of the plurality of unit cells, sealing the first, second, and third surfaces, wherein the first surface and the second surface are opposite to each other, the third surface and the fourth surface are opposite to each other, and the first surface and the second surface intersect the third surface and the fourth surface, introducing an electrolyte through the fourth surface, and sealing the fourth surface. Each of, or at least one of, the plurality of unit cells may include the composite current collector that has a top surface and a bottom surface that are opposite to each other, a first active material layer on the top surface of the composite current collector, and a second active material layer on the bottom surface of the composite current collector. The composite current collectors of neighboring unit cells may be in contact with each other.

### BRIEF DESCRIPTION OF DRAWINGS

FIG. 1 illustrates a simplified conceptual diagram illustrating a rechargeable lithium battery, according to an example embodiment of the present disclosure.

FIGS. 2 to 5 illustrate simplified diagrams illustrating a rechargeable lithium battery, according to an example embodiment of the present disclosure.

FIG. 6 illustrates a perspective view illustrating a rechargeable lithium battery, according to an example embodiment of the present disclosure.

FIG. 7 illustrates a cross-sectional view taken along line A-A′ of FIG. 6.

FIG. 8 illustrates a cross-sectional view taken along line II-II′ of FIG. 6.

FIGS. 9 to 21 illustrate diagrams illustrating a method of fabricating a rechargeable lithium battery, according to an example embodiment of the present disclosure.

FIG. 9 illustrates a perspective view illustrating a composite current collector, according to an example embodiment of the present disclosure.

FIG. 10 illustrates a cross-sectional view taken along line A-A′ of FIG. 9.

FIG. 11 illustrates a perspective view illustrating a unit cell, according to an example embodiment of the present disclosure.

FIG. 12 illustrates a cross-sectional view taken along line A-A′ of FIG. 11.

FIG. 13 illustrates a perspective view illustrating a plurality of stacked unit cells, according to an example embodiment of the present disclosure.

FIG. 14 illustrates a cross-sectional view taken along line A-A′ of FIG. 13.

FIG. 15 illustrates a perspective view illustrating a plurality of stacked unit cells, according to an example embodiment of the present disclosure.

FIG. 16 illustrates a cross-sectional view taken along line A-A′ of FIG. 15.

FIG. 17 illustrates a cross-sectional view taken along line B-B′ of FIG. 15.

FIG. 18 illustrates a perspective view illustrating a plurality of stacked unit cells, according to an example embodiment of the present disclosure.

FIG. 19 illustrates a cross-sectional view taken along line A-A′ of FIG. 18.

FIG. 20 illustrates a cross-sectional view taken along line B-B′ of FIG. 18.

FIG. 21 illustrates a perspective view illustrating a plurality of stacked unit cells, according to an example embodiment of the present disclosure.

FIG. 22 illustrates a cross-sectional view taken along line B-B′ of FIG. 21.

FIG. 23 is a flow chart illustrating a method of fabricating a rechargeable lithium battery, according to an example embodiment.

### DETAILED DESCRIPTION OF EMBODIMENTS

In order to sufficiently understand the configuration and effect of the present disclosure, some example embodiments of the present disclosure is described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it is understood that, when an element is referred to as being “on” another element, the element can be “directly on” the other element, or intervening elements may be present between therebetween. In the drawings, thicknesses of some components may be exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “and B. ” The terms “comprises/includes” and/or “comprising/including” used in this disclosure do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

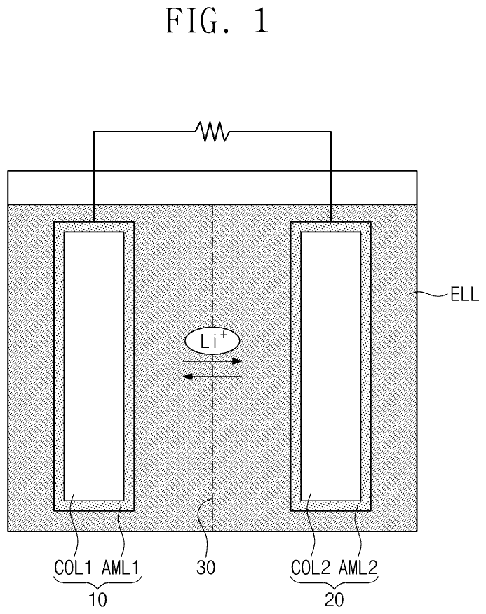

FIG. 1 is a simplified conceptual diagram illustrating a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be located between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1, and a positive electrode active material layer AML1 on the current collector COL1. The positive electrode active material layer AML1 may include a positive electrode active material, and may further include a binder and/or a conductive material.

For example, the positive electrode 10 may further include an additive that can be configured as a sacrificial positive electrode.

An amount of the positive electrode active material may be in a range of about 90 wt % to about 99.5 wt % relative to 100 wt % of the positive electrode active material layer AML1. An amount of each of the binder and the conductive material may be in a range of about 0.5 wt % to about 5 wt % relative to 100 wt % of the positive electrode active material layer AML1.

The binder may be configured to improve attachment of positive electrode active material particles to each other, and to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause a chemical change in a battery may be included as the conductive material. The conductive material may include, for example, a carbon-based material such as or including at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be included as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal such as or including at least one of cobalt, manganese, nickel, and a combination thereof.

The composite oxide may include lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α}(where 0.90≤a≤1.8, 0≤b≤0.5, 0≤c≤0.5, and 0<α<2); LiₐNi_{1-b-c}Mn_{b}X_{c}O_{2-α}D_{α}(where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li(_{3-f)}Fe₂(PO₄)₃ (where 0≤f≤2); LiₐFePO₄(where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high-nickel-based positive electrode active material having a nickel amount that is equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity, and thus may be applicable to a high-capacity and high-density rechargeable lithium battery.

### Negative Electrode 20

The negative electrode 20 for a rechargeable lithium battery may include a current collector COL2 and a negative electrode active material layer AML2 located on the current collector COL2. The negative electrode active material layer AML2 may include a negative electrode active material, and may further include a binder and/or a conductive material.

For example, the negative electrode active material layer AML2 may include a negative electrode active material in a range of about 90 wt % to about 99 wt %, a binder in a range of about 0.5 wt % to about 5 wt %, and a conductive material in a range of about 0 wt % to about 5 wt %.

The binder may be configured to improve attachment of negative electrode active material particles to each other, and to improve attachment of the negative electrode active material to the current collector COL2. The binder may include at least one of a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is included as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may be included to provide an electrode with conductivity, and any suitable conductive material that does not cause a chemical change in a battery may be included as the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include at least one of a Si-based negative electrode active material or a Sn-based negative electrode active material. The Si-based negative electrode active material may include at least one of silicon, silicon-carbon composite, SiOx (where 0<x<2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) located on a surface of the secondary particle. The amorphous carbon may also be located between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer located on a surface of the core.

The Si-based negative electrode active material or the Sn-based negative electrode active material may be included in combination with a carbon-based negative electrode active material.

### Separator 30

Based on type of the rechargeable lithium battery, the separator 30 may be between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer located on one surface, or on opposite surfaces, of the porous substrate, the coating layer including at least one of an organic material, an inorganic material, or a combination thereof.

The porous substrate may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material and another coating layer including an inorganic material.

### Electrolyte ELL

The electrolyte ELL for a rechargeable lithium battery may include a non-aqueous organic solvent and a lithium salt.

The non-aqueous organic solvent may be configured as a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include at least one of ethyl alcohol or isopropyl alcohol. The aprotic solvent may include at least one of nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be included alone or in a mixture of two or more substances.

In addition, when a carbonate-based solvent is included, a cyclic carbonate and a chain carbonate may be mixed, and the cyclic carbonate and the chain carbonate may be mixed in a volume ratio in a range of about 1:1 to about 1:9.

The lithium salt may be or include a material that dissolves in the non-aqueous organic solvent to be configured as a supply source of lithium ions in a battery, enables a basic operation of a rechargeable lithium battery and promotes the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato)borate (LiBOB)

### Rechargeable Lithium Battery

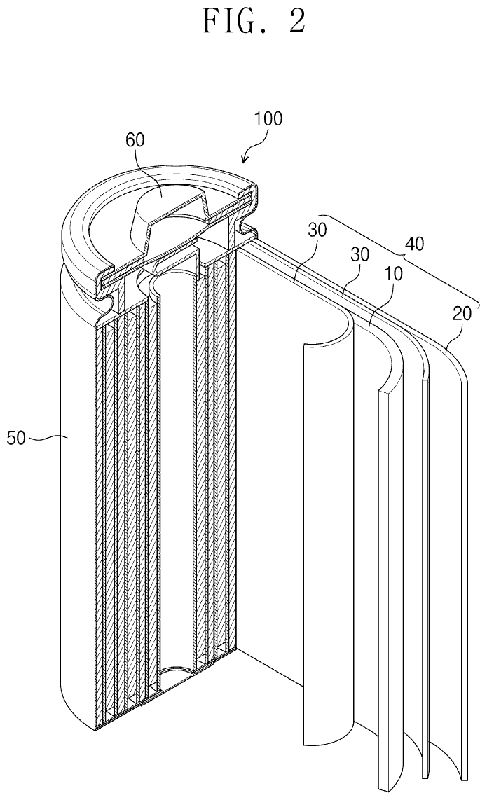

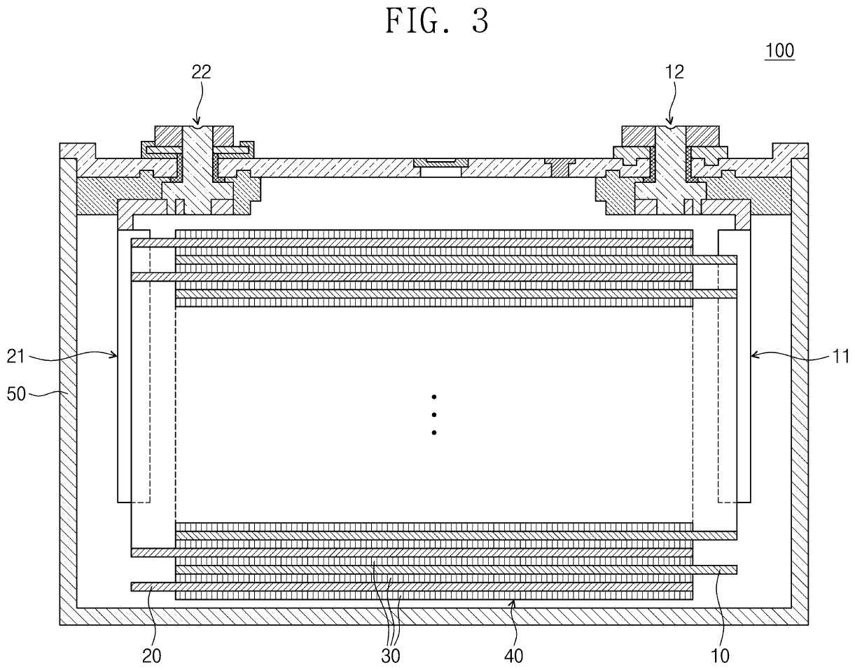

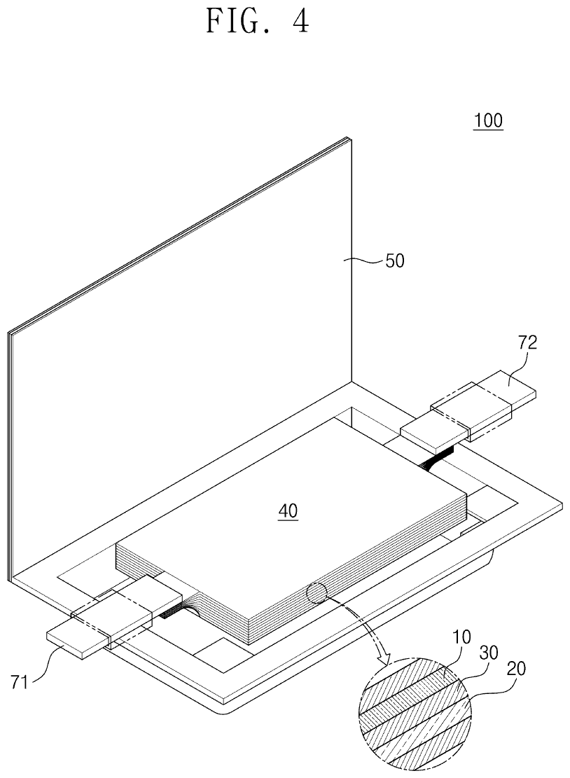

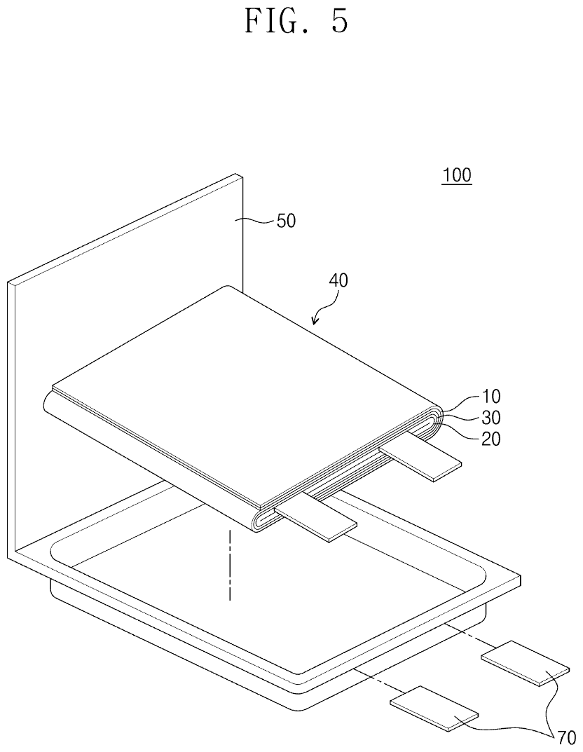

Based on the shape of a rechargeable lithium battery, the rechargeable lithium battery may be classified into cylindrical, prismatic, pouch, and coin types. FIGS. 2 to 5 illustrate simplified diagrams illustrating a rechargeable lithium battery according to an embodiment, with FIG. 2 illustrating a cylindrical battery, FIG. 3 illustrating a prismatic battery, and FIGS. 4 and 5 illustrating pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tabs 70/71/72 forming an electrical path for externally inducing a current generated in the electrode assembly 40.

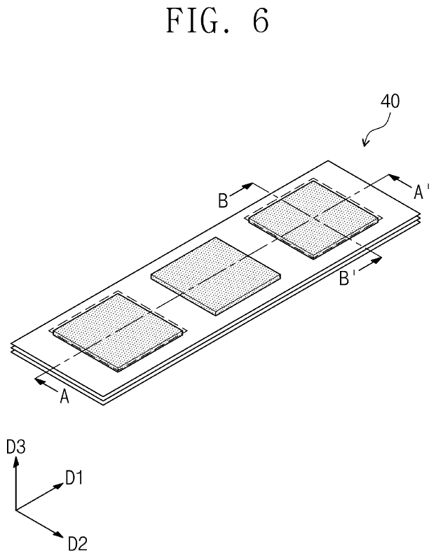

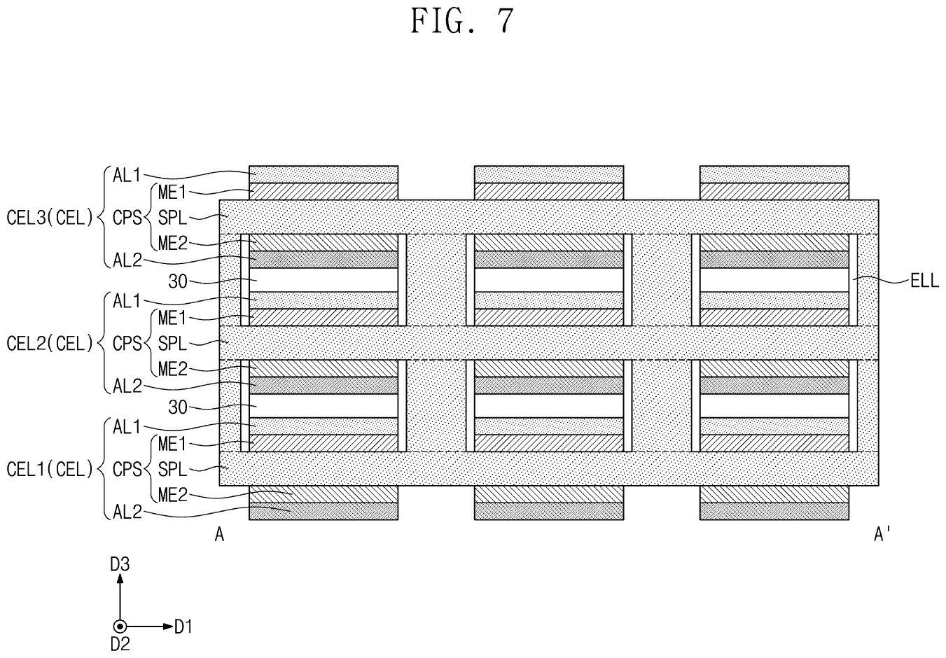

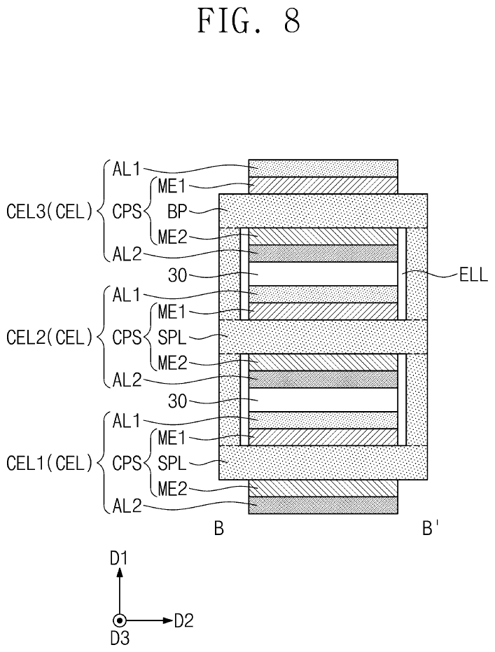

FIG. 6 illustrates a perspective view illustrating a rechargeable lithium battery, according to an example embodiment of the present disclosure. FIG. 7 illustrates a cross-sectional view taken along line A-A′ of FIG. 6. FIG. 8 illustrates a cross-sectional view taken along line B-B′ of FIG. 6. A redundant explanation of the rechargeable lithium battery discussed with reference to FIGS. 1 to 5 is omitted for brevity of description.

Referring to FIGS. 6 to 8, a rechargeable lithium battery according to some example embodiments of the present disclosure may include a plurality of stacked unit cells CEL1, CEL2, and CEL3, and a separator 30 and an electrolyte ELL interposed between the plurality of unit cells CEL1, CEL2, and CEL3. The separator 30 may correspond to the separator 30 discussed above with reference to FIG. 1.

The plurality of unit cells CEL1, CEL2, and CEL3 may be stacked along a third direction D3. The plurality of unit cells CEL1, CEL2, and CEL3 may include, for example, a first unit cell CEL1, a second unit cell CEL2 on the first unit cell CEL1, and a third unit cell CEL3 on the second unit cell CEL2. The first, second, and third unit cells CEL1, CEL2, and CEL3 may be electrically connected to each other.

Referring to FIG. 6, only three unit cells CEL1, CEL2, and CEL3 are illustrated, but the present disclosure is not limited thereto and, e.g., more than three unit cells may be stacked together.

Each of the plurality of unit cells CEL1, CEL2, and CEL3 may include a composite current collector CPS having a top surface and a bottom surface that are opposite to each other, a first active material layer AL1 on the top surface of the composite current collector CPS, and a second active material layer AL2 on the bottom surface of the composite current collector CPS.

The first active material layer AL1 may be or include one of the positive electrode active material layer AML1 and the negative electrode active material layer AML2 discussed above with reference to FIG. 1. The second active material layer AL2 may be or include the other of the positive electrode active material layer AML1 and the negative electrode active material layer AML2 discussed above with reference to FIG. 1. In an example embodiment of the present disclosure, the first active material layer AL1 may be the positive electrode active material layer AML1, and the second active material layer AL2 may be the negative electrode active material layer AML2.

The composite current collector CPS may include a support layer SPL, a first metal layer ME1 on a top surface of the support layer SPL, and a second metal layer ME2 on a bottom surface of the support layer SPL. Each of, or at least one of, the first metal layer ME1 and the second metal layer ME2 may have a thickness of, for example, in a range of about 200 nm to about 5 μm. The first active material layer AL1 may be located on the first metal layer ME1, and the second active material layer AL2 may be located on the second metal layer ME2. Each of the first and second metal layers ME1 and ME2 of the composite current collector CPS may correspond to one of the current collectors COL1 and COL2 discussed above with reference to FIG. 1. Each of, or at least one of, the first metal layer ME1 and the second metal layer ME2 may include at least one of aluminum, aluminum alloys, copper, copper alloys, nickel, nickel alloys, titanium, titanium alloys, iron, iron alloys, silver, and silver alloys.

The support layer SPL may be or include, for example, a porous film. A porosity of the support layer SPL may range, for example, from about 30% to about 70%, from about 35% to about 55%, from about 42% to about 64%, from about 31% to about 62%, or from about 48% to about 65%. A thickness of the support layer SPL may range, for example, from about 3 μm to about 10 μm. When the porosity and/or the thickness of the support layer SPL fall within the ranges above, the rechargeable lithium battery may exhibit desired or improved mechanical stability and high integration. The support layer SPL may include, for example, one or more of a polyethylene film, a polypropylene film, a polyvinylidene chloride film, and a multi-layered film of a combination thereof.

The composite current collectors CPS of neighboring unit cells among CEL1, CEL2, and CEL3 may be in contact with each other. For example, the support layers SPL of neighboring unit cells CEL1, CEL2, and CEL3 may be in contact with each other, and may be combined into a single unitary piece. The combined support layers SPL may surround the first metal layer ME1, the first active material layer AL1, the separator 30, the second metal layer ME2, and the second active material layer AL2.

For example, the support layer SPL of the first unit cell CEL1 and the support layer SPL of the second unit cell CEL2 may be combined into a single unitary piece. The combined support layers SPL may surround the first metal layer ME1 and the first active material layer AL1 of the first unit cell CEL1, the second metal layer ME2 and the second active material layer AL2 of the second unit cell CEL2, and the separator 30.

For example, the support layer SPL of the second unit cell CEL2 and the support layer SPL of the third unit cell CEL3 may be combined into a single unitary piece. The combined support layers SPL may surround the first metal layer ME1 and the first active material layer AL1 of the second unit cell CEL2, the second metal layer ME2 and the second active material layer AL2 of the third unit cell CEL3, and the separator 30.

The support layer SPL according to some example embodiments of the present disclosure may perform multiple functions of supporting and packaging for a composite substrate. Therefore, the rechargeable lithium battery may exhibit desired or improved spatial utilization.

The electrolyte ELL may be located in the combined support layers SPL. For example, the support layer SPL of the first unit cell CEL1 and the support layer SPL of the second unit cell CEL2 may be combined into a single unitary piece. The electrolyte ELL may fill an interior of the combined support layers SPL. For example, the support layer SPL of the second unit cell CEL2 and the support layer SPL of the third unit cell CEL3 may be combined into a single unitary piece. The electrolyte ELL may fill an interior of the combined support layers SPL.

The electrolyte ELL may be in contact with the first metal layer ME1, the first active material layer AL1, the second metal layer ME2, the second active material layer AL2, and the separator 30. The first metal layer ME1, the first active material layer AL1, the second metal layer ME2, the second active material layer AL2, and the separator 30 may be impregnated in the electrolyte ELL. The electrolyte ELL may correspond to the electrolyte ELL discussed with reference to FIG. 1.

The first unit cell CEL1, the second unit cell CEL2, the third unit cell CEL3, the electrolyte ELL, and the separator 30 of FIG. 6 may constitute the electrode assembly 40 discussed above with reference to FIGS. 3 to 5.

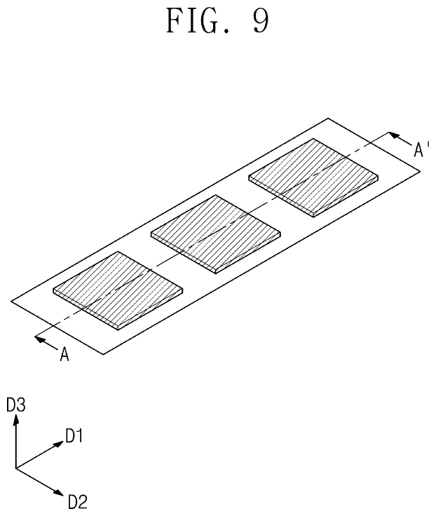

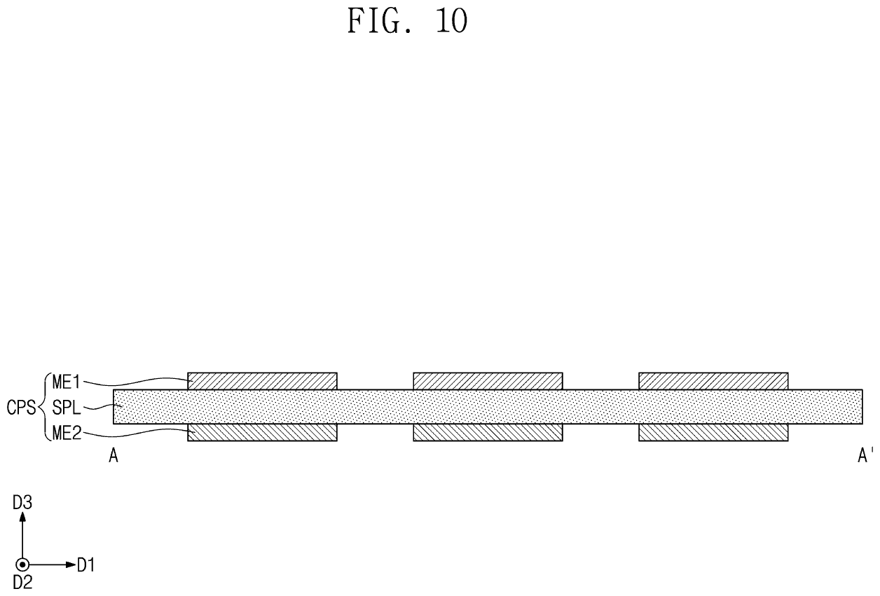

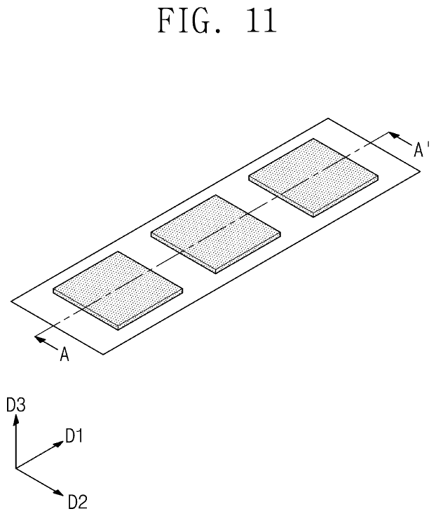

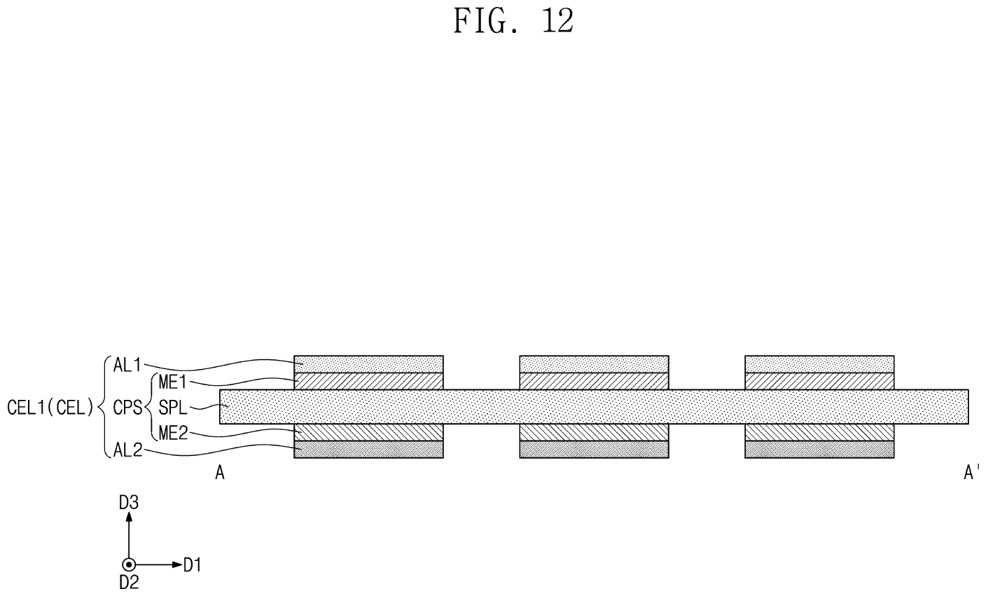

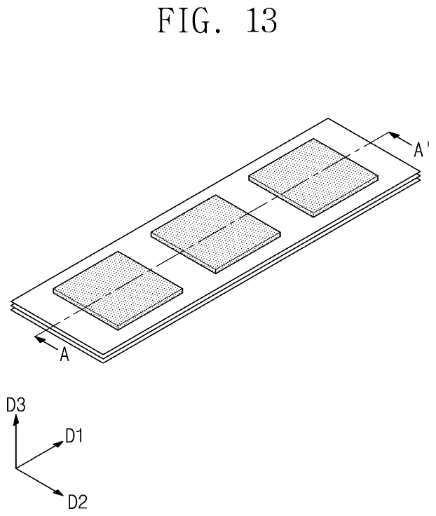

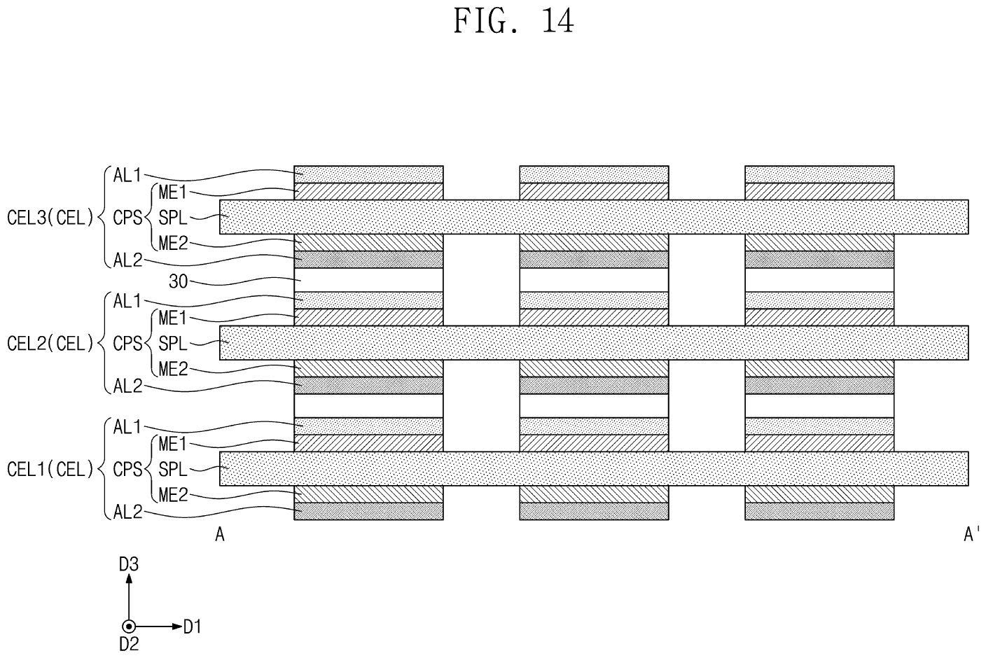

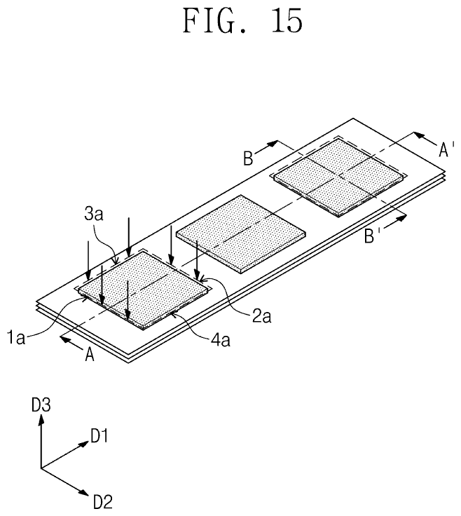

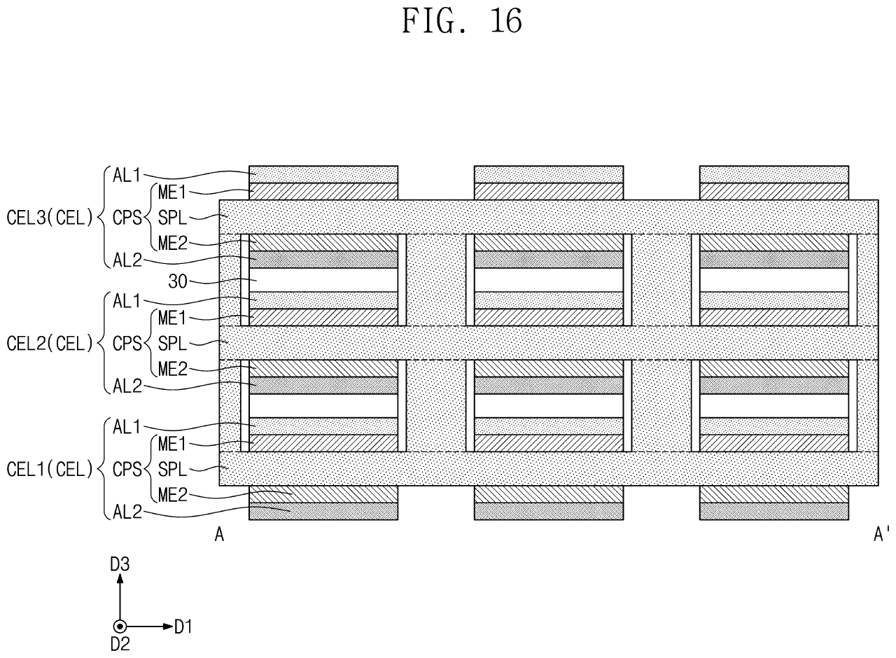

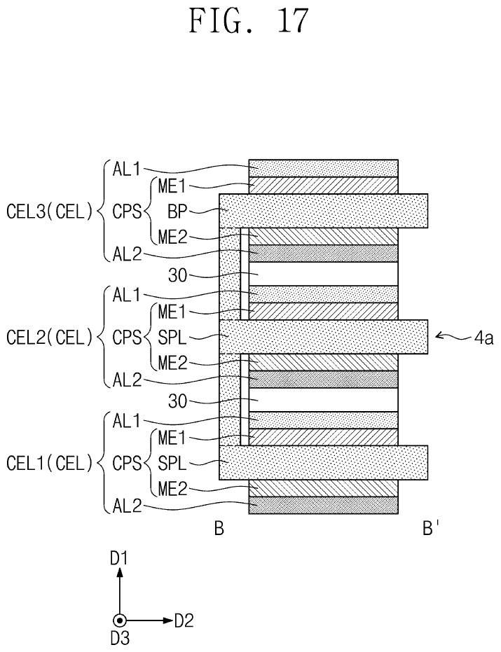

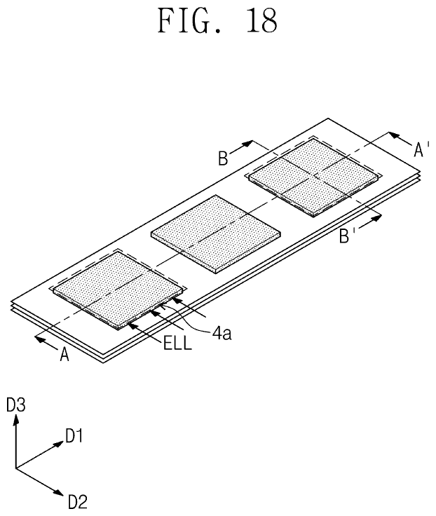

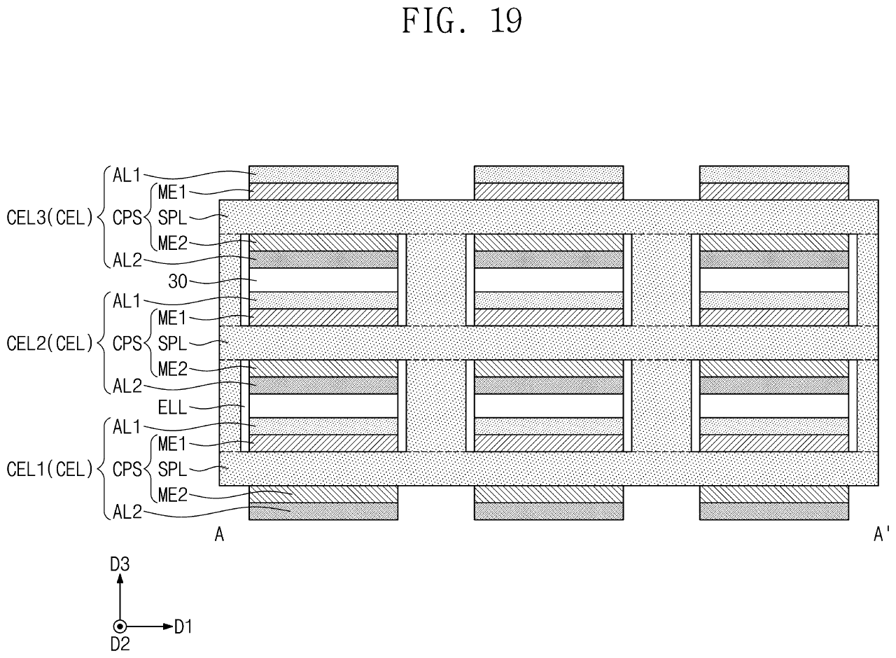

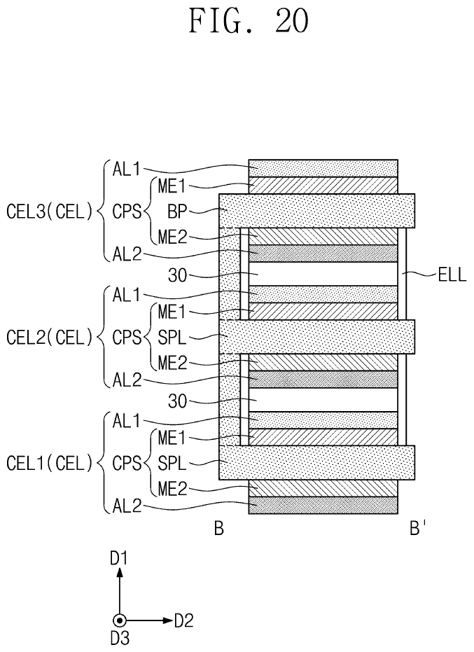

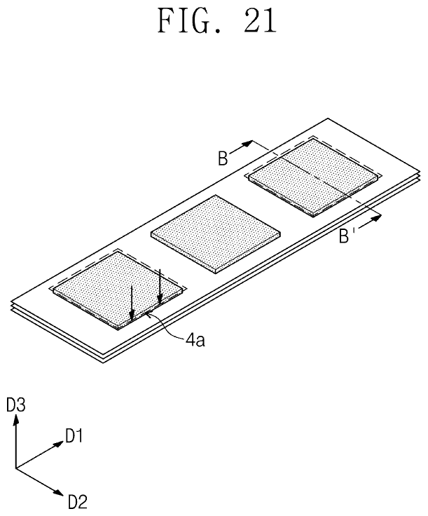

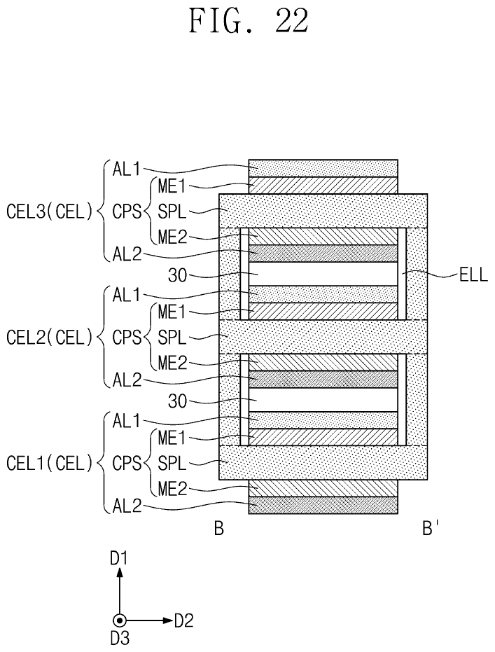

FIGS. 9 to 22 are diagrams illustrating a method of fabricating a rechargeable lithium battery, according to an example embodiment of the present disclosure. FIG. 9 is a perspective view illustrating a composite current collector according to an example embodiment of the present disclosure. FIG. 10 is a cross-sectional view taken along line A-A′ of FIG. 9. FIG. 11 is a perspective view illustrating a unit cell according to an example embodiment of the present disclosure. FIG. 12 illustrates a cross-sectional view taken along line A-A′ of FIG. 11. FIG. 13 is a perspective view illustrating a plurality of stacked unit cells according to an example embodiment of the present disclosure. FIG. 14 illustrates a cross-sectional view taken along line A-A′ of FIG. 13. FIG. 15 is a perspective view illustrating a plurality of stacked unit cells according to an example embodiment of the present disclosure. FIG. 16 illustrates a cross-sectional view taken along line A-A′ of FIG. 15. FIG. 17 illustrates a cross-sectional view taken along line B-B′ of FIG. 15. FIG. 18 is a perspective view illustrating a plurality of stacked unit cells according to an example embodiment of the present disclosure. FIG. 19 illustrates a cross-sectional view taken along line A-A′ of FIG. 18. FIG. 20 illustrates a cross-sectional view taken along line B-B′ of FIG. 18. FIG. 21 is a perspective view illustrating a plurality of stacked unit cells according to an example embodiment of the present disclosure. FIG. 22 illustrates a cross-sectional view taken along line B-B′ of FIG. 21. A redundant explanation of the rechargeable lithium battery discussed with reference to FIGS. 1 to 6 is omitted for brevity of description.

Referring to FIGS. 9 and 10, a composite current collector CPS may include a support layer SPL, a first metal layer ME1 on a top surface of the support layer SPL, and a second metal layer ME2 on a bottom surface of the support layer SPL. The support layer SPL may be or include, for example, a porous film. A porosity of the support layer SPL may range, for example, from about 30% to about 70%, from about 35% to about 55%, from about 42% to about 64%, from about 31% to about 62%, or from about 48% to about 65%. A thickness of the support layer SPL may range, for example, from about 3 μm to about 10 μm. Each of, or at least one of, the first metal layer ME1 and the second metal layer ME2 may have a thickness in a range of, for example, about 200 nm to about 5 μm. Each of, or at least one of, the first and second metal layers ME1 and ME2 may correspond to one of the current collectors COL1 and COL2 discussed above with reference to FIG. 1.

Referring to FIGS. 11 and 12, a first active material layer AL1 may be coated on the first metal layer ME1. A second active material layer AL2 may be coated on the second metal layer ME2. This coating process may form a first unit cell CEL1.

The first active material layer AL1 may be or include one of the positive electrode active material layer AML1 and the negative electrode active material layer AML2 discussed above with reference to FIG. 1. The second active material layer AL2 may be or include the other of the positive electrode active material layer AML1 and the negative electrode active material layer AML2 discussed above with reference to FIG. 1. In an example embodiment of the present disclosure, the first active material layer AL1 may be the positive electrode active material layer AML1, and the second active material layer AL2 may be the negative electrode active material layer AML2.

Referring to FIGS. 13 and 14, a plurality of unit cells CEL1, CEL2, and CEL3 may be stacked along a third direction D3. The plurality of unit cells CEL1, CEL2, and CEL3 may include, for example, a first unit cell CEL1, a second unit cell CEL2 on the first unit cell CEL1, and a third unit cell CEL3 on the second unit cell CEL2. The second unit cell CEL2 and the third unit cell CEL3 may be formed by the same method as the forming method of the first unit cell CEL1 discussed above with reference to FIGS. 9 to 12.

A separator 30 may be interposed between the plurality of unit cells CEL1, CEL2, and CEL3. The separator 30 may correspond to the separator 30 discussed above with reference to FIG. 1.

Referring to FIGS. 15 and 16, among a first surface 1a, a second surface 2a, a third surface 3a, and a fourth surface 4a of each of the plurality of unit cells CEL1, CEL2, and CEL3, the first, second, and third surfaces 1a, 2a, and 3a may be sealed. The first surface 1a and the second surface 2a may be opposite to each other, and the third surface 3a and the fourth surface 4a may be opposite to each other. The first surface 1a and the second surface 2a may intersect the third surface 3a and the fourth surface 4a.

The sealing process, such as, e.g., thermocompression, may combine the support layers SPL of the plurality of unit cells CEL1, CEL2, and CEL3 with each other. Therefore, the support layers SPL of the plurality of unit cells CEL1, CEL2, and CEL3 may be connected and/or in contact with each other. For example, during the sealing process, the support layers SPL of the plurality of unit cells CEL1, CEL2, and CEL3 may be combined into a single unitary piece.

Referring to FIGS. 17 and 18, the first metal layer ME1, the first active material layer AL1, the second metal layer ME2, and the second active material layer AL2 of each of the plurality of unit cells CEL1, CEL2, and CEL3 may be exposed through the fourth surface 4a that is not sealed.

Referring to FIGS. 19 and 20, an electrolyte ELL may be introduced through the non-sealed fourth surface 4a into the plurality of unit cells CEL1, CEL2, and CEL3. The electrolyte ELL may correspond to the electrolyte ELL discussed with reference to FIG. 1.

Referring to FIGS. 21 and 22, the fourth surfaces 4a of the plurality of unit cells CEL1, CEL2, and CEL3 may be sealed. The sealing process, such as, e.g., thermocompression, may combine the support layers SPL on the sides of the fourth surfaces 4a of the plurality of unit cells CEL1, CEL2, and CEL3 with each other.

The sealing process may finish all surfaces (e.g., the first, second, third, and fourth surfaces 1a, 2a, 3a, and 4a) of the plurality of unit cells CEL1, CEL2, and CEL3. During the sealing process, the electrolyte ELL may be sealed in an interior of the sealed support layer SPL. The sealing process may cause the electrolyte ELL to fill the interior of the combined support layers SPL. The first metal layer ME1, the first active material layer AL1, the second metal layer ME2, the second active material layer AL2, and the separator 30 may be impregnated in the electrolyte ELL.

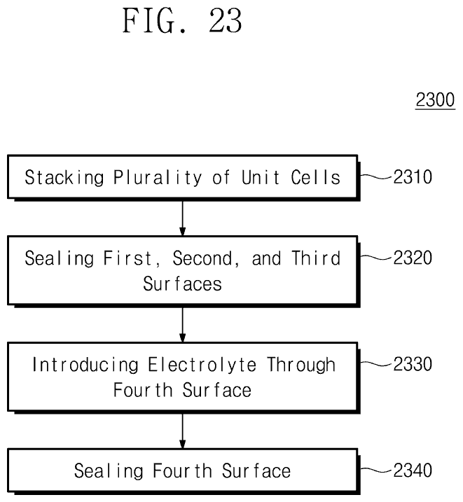

FIG. 23 is a flow chart illustrating a method of fabricating a rechargeable lithium battery, according to an example embodiment. In examples, the method 2300 starts at operation 2310, which includes stacking a plurality of unit cells. For example, each of, or at least one of, the plurality of unit cells includes a composite current collector. For example, the composite current collector includes a support layer, a first metal layer on a top surface of the support layer, and a second metal layer on a bottom surface of the support layer. In another example, the support layer includes one or more of a polyethylene film, a polypropylene film, a polyvinylidene chloride film, and a multi-layered film thereof. In yet another example, the support layers of neighboring unit cells are combined into a single unitary piece. For example, a porosity of the support layer is in a range of about 30% to about 70%. In an example, a thickness of at least one of the first metal layer and the second metal layer is in a range of about 200 nm to about 5 μm, and a thickness of the support layer is in a range of about 3 μm to about 10 μm.

Operation 2320 includes, among a first surface, a second surface, a third surface, and a fourth surface each of, or at least one of, the plurality of unit cells, sealing the first, second, and third surfaces. For example, the first surface and the second surface are opposite to each other. In another example, the third surface and the fourth surface are opposite to each other. In yet another example, the first surface and the second surface intersect the third surface and the fourth surface. Operation 2330 includes introducing an electrolyte through the fourth surface. Operation 2340 includes sealing the fourth surface. For example, each of, or at least one of, the plurality of unit cells includes the composite current collector that has a top surface and a bottom surface that are opposite to each other, a first active material layer on the top surface of the composite current collector, and a second active material layer on the bottom surface of the composite current collector. In another example, the composite current collectors of neighboring unit cells are in contact with each other.

According to some example embodiments of the present disclosure, each of, or at least one of, a plurality of stacked unit cells may include a composite current collector including a support layer, a first active material layer on a top surface of the composite current collector, and a second active material layer on a bottom surface of the composite current collector. The support layers of neighboring unit cells may be in contact with each other, and may be combined into a single unitary piece. Thus, an electrolyte may fill an interior of the combined support layers. It may therefore be possible to provide a rechargeable lithium battery including the composite current collector. In addition, the composite current collector may be included to provide a rechargeable lithium battery with desired or improved lightness and spatial utilization.

Although some example embodiments of the present disclosure have been discussed with reference to accompanying figures, it is understood that various changes in form and details may be made therein without departing from the spirit and scope of the present disclosure. It is apparent to those skilled in the art that various substitution, modifications, and changes may be made thereto without departing from the scope and spirit of the present disclosure.

What is claimed is

1. A rechargeable lithium battery, comprising:
a plurality of unit cells that are stacked together; and
a separator between the plurality of unit cells,
wherein each of the plurality of unit cells includes:
a composite current collector that has a top surface and a bottom surface that are opposite to each other;
a first active material layer on the top surface of the composite current collector; and
a second active material layer on the bottom surface of the composite current collector,
wherein the composite current collectors of neighboring unit cells are in contact with each other.

2. The rechargeable lithium battery of claim 1, wherein the composite current collector comprises:
a support layer that has a top surface and a bottom surface that are opposite to each other;
a first metal layer on the top surface of the support layer; and
a second metal layer on the bottom surface of the support layer.

3. The rechargeable lithium battery of claim 2, wherein the support layers of neighboring unit cells are in contact with each other.

4. The rechargeable lithium battery of claim 2, wherein the support layer comprises one or more of a polyethylene film, a polypropylene film, a polyvinylidene chloride film, and a multi-layered film of a combination thereof.

5. The rechargeable lithium battery of claim 2, wherein each of the first metal layer and the second metal layer comprises at least one of aluminum, aluminum alloys, copper, copper alloys, nickel, nickel alloys, titanium, titanium alloys, iron, iron alloys, silver, and silver alloys.

6. The rechargeable lithium battery of claim 2, wherein:
a thickness of at least one of the first metal layer and the second metal layer is in a range of about 200 nm to about 5 μm, and
a thickness of the support layer is in a range of about 3 μm to about 10 μm.

7. The rechargeable lithium battery of claim 2, wherein a porosity of the support layer is in a range of about 30% to about 70%.

8. The rechargeable lithium battery of claim 1, wherein at least one of the plurality of unit cells further comprises an electrolyte in contact with the first active material layer, the second active material layer, and the separator.

9. The rechargeable lithium battery of claim 2, wherein the support layers of neighboring unit cells are combined into a single unitary piece.

10. The rechargeable lithium battery of claim 1, wherein the plurality of unit cells are electrically connected to each other.

11. A rechargeable lithium battery, comprising:
a plurality of unit cells that are stacked;
a separator between the plurality of unit cells; and
an electrolyte in contact with the separator,
wherein at least one of the plurality of unit cells includes:
a composite current collector;
a first active material layer on a top surface of the composite current collector; and
a second active material layer on a bottom surface of the composite current collector,
wherein the electrolyte is in contact with the first active material layer, the second active material layer, and the separator, and
wherein the composite current collectors of neighboring unit cells are in contact with each other.

12. The rechargeable lithium battery of claim 11, wherein the composite current collector comprises:
a support layer;
a first metal layer on a top surface of the support layer; and
a second metal layer on a bottom surface of the support layer,
wherein the support layers of neighboring unit cells are combined into a single unitary piece, and
wherein the electrolyte fills an interior of the combined support layers.

13. The rechargeable lithium battery of claim 12, wherein the support layer comprises one or more of a polyethylene film, a polypropylene film, a polyvinylidene chloride film, and a multi-layered film thereof.

14. The rechargeable lithium battery of claim 12, wherein a porosity of the support layer is in a range of about 30% to about 70%.

15. A method of fabricating a rechargeable lithium battery, the method comprising:
stacking a plurality of unit cells, wherein each of the plurality of unit cells includes a composite current collector;
among a first surface, a second surface, a third surface, and a fourth surface of each of the plurality of unit cells, sealing the first, second, and third surfaces,
wherein the first surface and the second surface are opposite to each other,
wherein the third surface and the fourth surface are opposite to each other, and
wherein the first surface and the second surface intersect the third surface and the fourth surface;
introducing an electrolyte through the fourth surface; and
sealing the fourth surface,
wherein each of the plurality of unit cells includes:
the composite current collector that has a top surface and a bottom surface that are opposite to each other;
a first active material layer on the top surface of the composite current collector; and
a second active material layer on the bottom surface of the composite current collector,
wherein the composite current collectors of neighboring unit cells are in contact with each other.

16. The method of claim 15, wherein the composite current collector comprises:
a support layer;
a first metal layer on a top surface of the support layer; and
a second metal layer on a bottom surface of the support layer.

17. The method of claim 16, wherein the support layer comprises one or more of a polyethylene film, a polypropylene film, a polyvinylidene chloride film, and a multi-layered film thereof.

18. The method of claim 16, wherein the support layers of neighboring unit cells are combined into a single unitary piece.

19. The method of claim 16, wherein a porosity of the support layer is in a range of about 30% to about 70%.

20. The method of claim 16, wherein
a thickness of at least one of the first metal layer and the second metal layer is in a range of about 200 nm to about 5 μm, and
a thickness of the support layer is in a range of about 3 μm to about 10 μm.
